(19) United States
(12) Patent Application Publication
(10) Pub. No.: US 2022/0106485 A1
(43) Pub. Date: Apr. 7, 2022

(54) SURFACE COATED ELECTRICALLY CONDUCTIVE ELASTOMERS

(71) Applicant: Facebook Technologies, LLC, Menlo Park, CA (US)

(72) Inventors: Li YAO, Redmond, WA (US); Wenyang PAN, Redmond, WA (US); Shawn REESE, Renton, WA (US); Ning GUO, New York, NY (US); Muhammed Talha AGCAYAZI, Bothell, WA (US); Steven Joseph KOBER, New Canaan, CT (US)

(21) Appl. No.: 17/472,358

(22) Filed: Sep. 10, 2021

Related U.S. Application Data
(60) Provisional application No. 63/086,510, filed on Oct. 1, 2020.

(51) Int. Cl. C08L 75/16; C08G 18/67; C08L 65/00; C08K 3/013

(52) U.S. Cl. CPC C08L 75/16; C08K 3/013; C08L 65/00; C08G 18/672

(57) ABSTRACT

The disclosure provides electrically conductive elastomers.

### CROSS-REFERENCE TO RELATED PATENT APPLICATION

The present application claims priority to U.S. Provisional Patent Application No. 63/086,510, entitled “Surface Coated Electrically Conductive Elastomers Based On Urethane-Acrylate Cured With Multifunctional Thiol By Michael-Addition,” filed Oct. 1, 2020, which is hereby incorporated by reference in its entirety.

### FIELD

Described herein are conductive elastomers, including conductive elastomers with low surface impedance, methods of making and using thereof, and devices using such elastomers.

### BACKGROUND

Conductive elastomers can be used for developing soft electrodes, soft actuators, and soft sensors. They are particularly important for EMG electrodes, which convert motoneuron signals into electrical signals; the electrical signals are then processed and amplified for external device control. In order to maximize the performance of EMG electrodes, high conductivity as well as good compatibility with human body/skin are needed. However, to increase the conductivity, high volume of conductive filler loading is usually needed which decreases the elastomer's stretchability. Due to its stretchability, silicone elastomer can be used as filler host to make conductive elastomers. However, it is hydrophobic, and thus difficult to be compatible with other materials. The silicone oil bleeding problem from silicone elastomer also makes it not preferred for electronic applications.

### BRIEF DESCRIPTION OF THE DRAWINGS

The foregoing summary, as well as the following detailed description of the present disclosure, will be better understood when read in conjunction with the appended drawings.

FIG. 1A illustrates generic steps for forming a PEDOT:PSS coated urethane acrylate elastomer; FIG. 1B illustrates a comparative example where a PEDOT:PSS coated silicone cannot be fabricated.

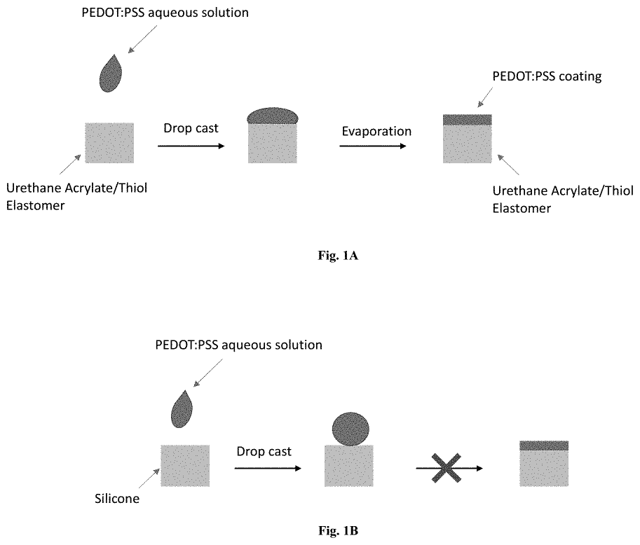

### DETAILED DESCRIPTION

### Definitions

Unless defined otherwise, all technical and scientific terms used herein have the same meaning as is commonly understood by one of skill in the art to which this disclosure belongs. All patents and publications referred to herein are incorporated by reference in their entireties.

When ranges are used herein to describe, for example, physical or chemical properties such as molecular weight or chemical formulae, all combinations and subcombinations of ranges and specific embodiments therein are intended to be included. Use of the term “about” when referring to a number or a numerical range means that the number or numerical range referred to is an approximation within experimental variability (or within statistical experimental error), and thus the number or numerical range may vary. The variation is typically from 0% to 15%, or from 0% to 10%, or from 0% to 5% of the stated number or numerical range. The term “including” (and related terms such as “comprise” or “comprises” or “having” or “including”) includes those embodiments such as, for example, an embodiment of any composition of matter, method or process that “consist of” or “consist essentially of” the described features.

Unless otherwise stated, the chemical structures depicted herein are intended to include compounds which differ only in the presence of one or more isotopically enriched atoms. For example, compounds where one or more hydrogen atoms is replaced by deuterium or tritium, or where one or more carbon atoms is replaced by ¹³C- or ¹⁴C-enriched carbons, are within the scope of this disclosure.

“Alkyl” refers to a straight or branched hydrocarbon chain radical consisting solely of carbon and hydrogen atoms, containing no unsaturation, having from one to ten carbon atoms (e.g., (C₁₋₁₀)alkyl or C₁₋₁₀ alkyl). Whenever it appears herein, a numerical range such as “1 to 10” refers to each integer in the given range—e.g., “1 to 10 carbon atoms” means that the alkyl group may consist of 1 carbon atom, 2 carbon atoms, 3 carbon atoms, etc., up to and including 10 carbon atoms, although the definition is also intended to cover the occurrence of the term “alkyl” where no numerical range is specifically designated. Typical alkyl groups include, but are in no way limited to, methyl, ethyl, propyl, isopropyl, n-butyl, isobutyl, sec-butyl isobutyl, tertiary butyl, pentyl, isopentyl, neopentyl, hexyl, septyl, octyl, nonyl and decyl. The alkyl moiety may be attached to the rest of the molecule by a single bond, such as for example, methyl (Me), ethyl (Et), n-propyl (Pr), 1-methylethyl (isopropyl), n-butyl, n-pentyl, 1,1-dimethylethyl (t-butyl) and 3-methylhexyl. Unless stated otherwise specifically in the specification, an alkyl group is optionally substituted by one or more of substituents which are independently heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a})₂, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂ where each R^{a} is independently hydrogen, fluoroalkyl, carbocyclyl, carbocyclylalkyl, aryl, aralkyl, heterocycloalkyl, heterocycloalkylalkyl, heteroaryl or heteroarylalkyl.

“Alkylaryl” refers to an -(alkyl)aryl radical where aryl and alkyl are as disclosed herein and which are optionally substituted by one or more of the substituents described as suitable substituents for aryl and alkyl respectively.

“Alkylhetaryl” refers to an -(alkyl)hetaryl radical where hetaryl and alkyl are as disclosed herein and which are optionally substituted by one or more of the substituents described as suitable substituents for aryl and alkyl respectively.

“Alkylheterocycloalkyl” refers to an -(alkyl) heterocyclyl radical where alkyl and heterocycloalkyl are as disclosed herein and which are optionally substituted by one or more of the substituents described as suitable substituents for heterocycloalkyl and alkyl respectively.

An “alkene” moiety refers to a group consisting of at least two carbon atoms and at least one carbon-carbon double bond, and an “alkyne” moiety refers to a group consisting of at least two carbon atoms and at least one carbon-carbon triple bond. The alkyl moiety, whether saturated or unsaturated, may be branched, straight chain, or cyclic.

“Alkenyl” refers to a straight or branched hydrocarbon chain radical group consisting solely of carbon and hydrogen atoms, containing at least one double bond, and having from two to ten carbon atoms (e.g., (C₂₋₁₀)alkenyl or C₂₋₁₀ alkenyl). Whenever it appears herein, a numerical range such as “2 to 10” refers to each integer in the given range—e.g., “2 to 10 carbon atoms” means that the alkenyl group may consist of 2 carbon atoms, 3 carbon atoms, etc., up to and including 10 carbon atoms. The alkenyl moiety may be attached to the rest of the molecule by a single bond, such as for example, ethenyl (e.g., vinyl), prop-1-enyl (e.g., allyl), but-1-enyl, pent-1-enyl and penta-1,4-dienyl. Unless stated otherwise specifically in the specification, an alkenyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each IV is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Alkenyl-cycloalkyl” refers to an -(alkenyl)cycloalkyl radical where alkenyl and cycloalkyl are as disclosed herein and which are optionally substituted by one or more of the substituents described as suitable substituents for alkenyl and cycloalkyl respectively.

“Amino” or “amine” refers to a —N(R^{a})₂ radical group, where each IV is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl, unless stated otherwise specifically in the specification. When a —N(R^{a})₂ group has two IV substituents other than hydrogen, they can be combined with the nitrogen atom to form a 4-, 5-, 6- or 7-membered ring. For example, —N(R^{a})₂ is intended to include, but is not limited to, 1-pyrrolidinyl and 4-morpholinyl. Unless stated otherwise specifically in the specification, an amino group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), —S(O)ₜN(R^{a})C(O)R^{a} (where t is 1 or 2), or PO₃(R^{a})₂, where each IV is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “substituted amino” also refers to N-oxides of the groups —NHR^{d}, and NR^{d}R^{d} each as described above. N-oxides can be prepared by treatment of the corresponding amino group with, for example, hydrogen peroxide or m-chloroperoxybenzoic acid.

“Amide” or “amido” refers to a chemical moiety with formula —C(O)N(R)₂ or —NHC(O)R, where R is selected from the group consisting of hydrogen, alkyl, cycloalkyl, aryl, heteroaryl (bonded through a ring carbon) and heteroalicyclic (bonded through a ring carbon), each of which moiety may itself be optionally substituted. The R₂ of —N(R)₂ of the amide may optionally be taken together with the nitrogen to which it is attached to form a 4-, 5-, 6- or 7-membered ring. Unless stated otherwise specifically in the specification, an amido group is optionally substituted independently by one or more of the substituents as described herein for alkyl, cycloalkyl, aryl, heteroaryl, or heterocycloalkyl. An amide may be an amino acid or a peptide molecule attached to a compound disclosed herein, thereby forming a prodrug. The procedures and specific groups to make such amides are known to those of skill in the art and can readily be found in seminal sources such as Greene and Wuts, Protective Groups in Organic Synthesis, 3^{rd} Ed., John Wiley & Sons, New York, N.Y., 1999, which is incorporated herein by reference in its entirety.

“Aromatic” or “aryl” or “Ar” refers to an aromatic radical with six to ten ring atoms (e.g., C₆-C₁₀ aromatic or C₆-C₁₀ aryl) which has at least one ring having a conjugated pi electron system which is carbocyclic (e.g., phenyl, fluorenyl, and naphthyl). Bivalent radicals formed from substituted benzene derivatives and having the free valences at ring atoms are named as substituted phenylene radicals. Bivalent radicals derived from univalent polycyclic hydrocarbon radicals whose names end in “-yl” by removal of one hydrogen atom from the carbon atom with the free valence are named by adding “-idene” to the name of the corresponding univalent radical, e.g., a naphthyl group with two points of attachment is termed naphthylidene. Whenever it appears herein, a numerical range such as “6 to 10” refers to each integer in the given range; e.g., “6 to 10 ring atoms” means that the aryl group may consist of 6 ring atoms, 7 ring atoms, etc., up to and including 10 ring atoms. The term includes monocyclic or fused-ring polycyclic (e.g., rings which share adjacent pairs of ring atoms) groups. Unless stated otherwise specifically in the specification, an aryl moiety is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR′, —SR′, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each IV is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl. It is understood that a substituent R attached to an aromatic ring at an unspecified position,

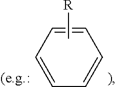

includes one or more, and up to the maximum number of possible substituents.

The term “aryloxy” refers to the group —O-aryl.

The term “substituted aryloxy” refers to aryloxy where the aryl substituent is substituted (e.g., —O-(substituted aryl)). Unless stated otherwise specifically in the specification, the aryl moiety of an aryloxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR′, —SR′, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Aralkyl” or “arylalkyl” refers to an (aryl)alkyl-radical where aryl and alkyl are as disclosed herein and which are optionally substituted by one or more of the substituents described as suitable substituents for aryl and alkyl respectively.

“Ester” refers to a chemical radical of formula —COOR, where R is selected from the group consisting of alkyl, cycloalkyl, aryl, heteroaryl (bonded through a ring carbon) and heteroalicyclic (bonded through a ring carbon). The procedures and specific groups to make esters are known to those of skill in the art and can readily be found in seminal sources such as Greene and Wuts, Protective Groups in Organic Synthesis, 3^{rd} Ed., John Wiley & Sons, New York, N.Y., 1999, which is incorporated herein by reference in its entirety. Unless stated otherwise specifically in the specification, an ester group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Fluoroalkyl” refers to an alkyl radical, as defined above, that is substituted by one or more fluoro radicals, as defined above, for example, trifluoromethyl, difluoromethyl, 2,2,2-trifluoroethyl, 1-fluoromethyl-2-fluoroethyl, and the like. The alkyl part of the fluoroalkyl radical may be optionally substituted as defined above for an alkyl group.

“Halo,” “halide,” or, alternatively, “halogen” is intended to mean fluoro, chloro, bromo or iodo. The terms “haloalkyl,” “haloalkenyl,” “haloalkynyl,” and “haloalkoxy” include alkyl, alkenyl, alkynyl and alkoxy structures that are substituted with one or more halo groups or with combinations thereof. For example, the terms “fluoroalkyl” and “fluoroalkoxy” include haloalkyl and haloalkoxy groups, respectively, in which the halo is fluorine.

“Heteroalkyl,” “heteroalkenyl,” and “heteroalkynyl” refer to optionally substituted alkyl, alkenyl and alkynyl radicals and which have one or more skeletal chain atoms selected from an atom other than carbon, e.g., oxygen, nitrogen, sulfur, phosphorus or combinations thereof. A numerical range may be given—e.g., C₁-C₄ heteroalkyl which refers to the chain length in total, which in this example is 4 atoms long. A heteroalkyl group may be substituted with one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each IV is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heteroalkylaryl” refers to an -(heteroalkyl)aryl radical where heteroalkyl and aryl are as disclosed herein and which are optionally substituted by one or more of the substituents described as suitable substituents for heteroalkyl and aryl, respectively.

“Heteroalkylheteroaryl” refers to an -(heteroalkyl)heteroaryl radical where heteroalkyl and heteroaryl are as disclosed herein and which are optionally substituted by one or more of the substituents described as suitable substituents for heteroalkyl and heteroaryl, respectively.

“Heteroalkylheterocycloalkyl” refers to an -(heteroalkyl)heterocycloalkyl radical where heteroalkyl and heterocycloalkyl are as disclosed herein and which are optionally substituted by one or more of the substituents described as suitable substituents for heteroalkyl and heterocycloalkyl, respectively.

“Heteroalkylcycloalkyl” refers to an -(heteroalkyl)cycloalkyl radical where heteroalkyl and cycloalkyl are as disclosed herein and which are optionally substituted by one or more of the substituents described as suitable substituents for heteroalkyl and cycloalkyl, respectively.

“Heteroaryl” or “heteroaromatic” or “HetAr” refers to a 5- to 18-membered aromatic radical (e.g., C₅-C₁₃ heteroaryl) that includes one or more ring heteroatoms selected from nitrogen, oxygen and sulfur, and which may be a monocyclic, bicyclic, tricyclic or tetracyclic ring system. Whenever it appears herein, a numerical range such as “5 to 18” refers to each integer in the given range—e.g., “5 to 18 ring atoms” means that the heteroaryl group may consist of 5 ring atoms, 6 ring atoms, etc., up to and including 18 ring atoms. Bivalent radicals derived from univalent heteroaryl radicals whose names end in “-yl” by removal of one hydrogen atom from the atom with the free valence are named by adding “-idene” to the name of the corresponding univalent radical—e.g., a pyridyl group with two points of attachment is a pyridylidene. A N-containing “heteroaromatic” or “heteroaryl” moiety refers to an aromatic group in which at least one of the skeletal atoms of the ring is a nitrogen atom. The polycyclic heteroaryl group may be fused or non-fused. The heteroatom(s) in the heteroaryl radical are optionally oxidized. One or more nitrogen atoms, if present, are optionally quaternized. The heteroaryl may be attached to the rest of the molecule through any atom of the ring(s). Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzoxazolyl, benzopyranyl, benzopyranonyl, benzofuranyl, benzofuranonyl, benzofurazanyl, benzothiazolyl, benzothienyl(benzothiophenyl), benzothieno[3,2-d]pyrimidinyl, benzotriazolyl, benzo[4,6]imidazo[1,2-c]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furazanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyranyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, thiapyranyl, triazolyl, tetrazolyl, triazinyl, thieno[2,3-d]pyrimidinyl, thieno[3,2-d]pyrimidinyl, thieno[2,3-c]pyridinyl, and thiophenyl (e.g., thienyl). Unless stated otherwise specifically in the specification, a heteroaryl moiety is optionally substituted by one or more substituents which are independently: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each IV is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

Substituted heteroaryl also includes ring systems substituted with one or more oxide (—O—) substituents, such as, for example, pyridinyl N-oxides.

“Heteroarylalkyl” refers to a moiety having an aryl moiety, as described herein, connected to an alkylene moiety, as described herein, where the connection to the remainder of the molecule is through the alkylene group.

“Heterocycloalkyl” refers to a stable 3- to 18-membered non-aromatic ring radical that comprises two to twelve carbon atoms and from one to six heteroatoms selected from nitrogen, oxygen and sulfur. Whenever it appears herein, a numerical range such as “3 to 18” refers to each integer in the given range—e.g., “3 to 18 ring atoms” means that the heterocycloalkyl group may consist of 3 ring atoms, 4 ring atoms, etc., up to and including 18 ring atoms. Unless stated otherwise specifically in the specification, the heterocycloalkyl radical is a monocyclic, bicyclic, tricyclic or tetracyclic ring system, which may include fused or bridged ring systems. The heteroatoms in the heterocycloalkyl radical may be optionally oxidized. One or more nitrogen atoms, if present, are optionally quaternized. The heterocycloalkyl radical is partially or fully saturated. The heterocycloalkyl may be attached to the rest of the molecule through any atom of the ring(s). Examples of such heterocycloalkyl radicals include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. Unless stated otherwise specifically in the specification, a heterocycloalkyl moiety is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, —OR^{a}, —SR^{a}, —OC(O)—R^{a}, —N(R^{a})₂, —C(O)R^{a}, —C(O)OR^{a}, —C(O)SR^{a}, —SC(O)R^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ᵣR^{a} (where t is 1 or 2), —S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heterocycloalkyl” also includes bicyclic ring systems where one non-aromatic ring, usually with 3 to 7 ring atoms, contains at least 2 carbon atoms in addition to 1-3 heteroatoms independently selected from oxygen, sulfur, and nitrogen, as well as combinations including at least one of the foregoing heteroatoms; and the other ring, usually with 3 to 7 ring atoms, optionally contains 1-3 heteroatoms independently selected from oxygen, sulfur, and nitrogen and is not aromatic.

“Nitro” refers to the —NO₂ radical.

“Oxa” refers to the —O— radical.

“Oxo” refers to the ═O radical.

“Isomers” are different compounds that have the same molecular formula. “Stereoisomers” are isomers that differ only in the way the atoms are arranged in space—e.g., having a different stereochemical configuration. “Enantiomers” are a pair of stereoisomers that are non-superimposable mirror images of each other. A 1:1 mixture of a pair of enantiomers is a “racemic” mixture. The term “(±)” is used to designate a racemic mixture where appropriate. “Diastereoisomers” are stereoisomers that have at least two asymmetric atoms, but which are not mirror-images of each other. The absolute stereochemistry is specified according to the Cahn-Ingold-Prelog R-S system. When a compound is a pure enantiomer the stereochemistry at each chiral carbon can be specified by either (R) or (9. Resolved compounds whose absolute configuration is unknown can be designated (+) or (−) depending on the direction (dextro- or levorotatory) which they rotate plane polarized light at the wavelength of the sodium D line. Certain of the compounds described herein contain one or more asymmetric centers and can thus give rise to enantiomers, diastereomers, and other stereoisomeric forms that can be defined, in terms of absolute stereochemistry, as (R) or (9. The present chemical entities, compositions and methods are meant to include all such possible isomers, including racemic mixtures, optically pure forms and intermediate mixtures. Optically active (R)- and (9-isomers can be prepared using chiral synthons or chiral reagents, or resolved using conventional techniques. When the compounds described herein contain olefinic double bonds or other centers of geometric asymmetry, and unless specified otherwise, it is intended that the compounds include both E and Z geometric isomers.

“Moiety” refers to a specific segment or functional group of a molecule. Chemical moieties are often recognized chemical entities embedded in or appended to a molecule.

“Tautomers” are structurally distinct isomers that interconvert by tautomerization. “Tautomerization” is a form of isomerization and includes prototropic or proton-shift tautomerization, which is considered a subset of acid-base chemistry. “Prototropic tautomerization” or “proton-shift tautomerization” involves the migration of a proton accompanied by changes in bond order, often the interchange of a single bond with an adjacent double bond. Where tautomerization is possible (e.g., in solution), a chemical equilibrium of tautomers can be reached. An example of tautomerization is keto-enol tautomerization. A specific example of keto-enol tautomerization is the interconversion of pentane-2,4-dione and 4-hydroxypent-3-en-2-one tautomers. Another example of tautomerization is phenol-keto tautomerization. A specific example of phenol-keto tautomerization is the interconversion of pyridin-4-ol and pyridin-4(1H)-one tautomers.

A “leaving group or atom” is any group or atom that will, under selected reaction conditions, cleave from the starting material, thus promoting reaction at a specified site. Examples of such groups, unless otherwise specified, include halogen atoms and mesyloxy, p-nitrobenzensulphonyloxy and tosyloxy groups.

“Protecting group” is intended to mean a group that selectively blocks one or more reactive sites in a multifunctional compound such that a chemical reaction can be carried out selectively on another unprotected reactive site and the group can then be readily removed or deprotected after the selective reaction is complete. A variety of protecting groups are disclosed, for example, in T. H. Greene and P. G. M. Wuts, Protective Groups in Organic Synthesis, Third Edition, John Wiley & Sons, New York (1999).

“Solvate” refers to a compound in physical association with one or more molecules of a pharmaceutically acceptable solvent.

“Substituted” means that the referenced group may have attached one or more additional groups, radicals or moieties individually and independently selected from, for example, acyl, alkyl, alkylaryl, cycloalkyl, aralkyl, aryl, carbohydrate, carbonate, heteroaryl, heterocycloalkyl, hydroxy, alkoxy, aryloxy, mercapto, alkylthio, arylthio, cyano, halo, carbonyl, ester, thiocarbonyl, isocyanato, thiocyanato, isothiocyanato, nitro, oxo, perhaloalkyl, perfluoroalkyl, phosphate, silyl, sulfinyl, sulfonyl, sulfonamidyl, sulfoxyl, sulfonate, urea, and amino, including mono- and di-substituted amino groups, and protected derivatives thereof. The substituents themselves may be substituted, for example, a cycloalkyl substituent may itself have a halide substituent at one or more of its ring carbons. The term “optionally substituted” means optional substitution with the specified groups, radicals or moieties.

Compounds of the present disclosure also include crystalline and amorphous forms of those compounds, including, for example, polymorphs, pseudopolymorphs, solvates, hydrates, unsolvated polymorphs (including anhydrates), conformational polymorphs, and amorphous forms of the compounds, as well as mixtures thereof. “Crystalline form” and “polymorph” are intended to include all crystalline and amorphous forms of the compound, including, for example, polymorphs, pseudopolymorphs, solvates, hydrates, unsolvated polymorphs (including anhydrates), conformational polymorphs, and amorphous forms, as well as mixtures thereof, unless a particular crystalline or amorphous form is referred to.

For the avoidance of doubt, it is intended herein that particular features (for example integers, characteristics, values, uses, diseases, formulae, compounds or groups) described in conjunction with a particular aspect, embodiment or example of the disclosure are to be understood as applicable to any other aspect, embodiment or example described herein unless incompatible therewith. Thus, such features may be used where appropriate in conjunction with any of the definition, claims or embodiments defined herein. All of the features disclosed in this specification (including any accompanying claims, abstract and drawings), and/or all of the steps of any method or process so disclosed, may be combined in any combination, except combinations where at least some of the features and/or steps are mutually exclusive. The present disclosure is not restricted to any details of any disclosed embodiments. The present disclosure extends to any novel one, or novel combination, of the features disclosed in this specification (including any accompanying claims, abstract and drawings), or to any novel one, or any novel combination, of the steps of any method or process so disclosed.

The disclosure provides a silicone-free elastomer based on urethane acrylate, which is as stretchable as silicone while more hydrophilic be able to be coated with various different materials, especially PEDOT:PSS layers. Without wishing to be bound by any particular theory, it is believed that the PEDOT:PSS coating between the conductive elastomer and the skin can efficiently reduce the contact electrical impedance to improve EMG signals.

In some embodiments, an elastomer can be prepared according to Scheme 1. “Core 1” can be any molecular frame that can have one or more pending thiol groups. In some embodiments, one or more thiol groups can be replaced by any suitable nucleophilic group. In some embodiments, p is any integer from 1 to 12. In some embodiments, p is any integer from 2 to 12. In some embodiments, p is any integer from 3 to 12. In some embodiments, p is any integer from 3 to 5. In some embodiments, p is any integer from 3 to 6. In some embodiments, p is at least 2, at least 3, at least 4, at least 5, or at least 6. In some embodiments, p is 1. In some embodiments, p is 2. In some embodiments, p is 3. In some embodiments, p is 4. In some embodiments, p is 5. In some embodiments, p is 6. In some embodiments, p is 7. In some embodiments, p is 8. In some embodiments, p is 9. In some embodiments, p is 10. In some embodiments, Core 1 comprises one or more of a substituted alkyl moiety, and one or more linking groups selected from —C₁₋₁₀ alkyl-, —O—C₁₋₁₀ alkyl-, —C₁₋₁₀ alkenyl-, —O—C₁₋₁₀ alkenyl-, —O—C₁₋₁₀ cycloalkenyl-, —C₁₋₁₀ alkynyl-, —O—C₁₋₁₀ alkynyl-, —C₁₋₁₀ aryl-, —O—C₁₋₁₀ aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl.

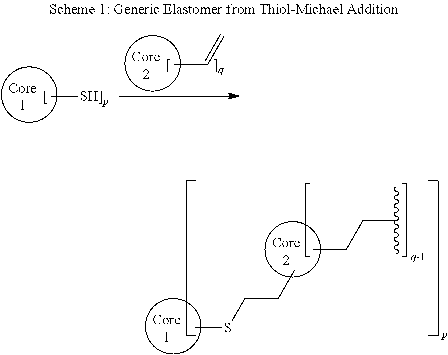

“Core 2” can be any molecular frame that can have one or more pending double bonds. In some embodiments, q is any integer from 1 to 12. In some embodiments, q is any integer from 2 to 12. In some embodiments, q is any integer from 3 to 12. In some embodiments, q is any integer from 3 to 5. In some embodiments, q is any integer from 3 to 6. In some embodiments, q is at least 2, at least 3, at least 4, at least 5, or at least 6. In some embodiments, q is 1. In some embodiments, q is 2. In some embodiments, q is 3. In some embodiments, q is 4. In some embodiments, q is 5. In some embodiments, q is 6. In some embodiments, q is 7. In some embodiments, q is 8. In some embodiments, q is 9. In some embodiments, q is 10. In some embodiments, Core 2 comprises one or more linking groups selected from —C₁₋₁₀ alkyl-, —O—C₁₋₁₀ alkyl-, —C₁₋₁₀ alkenyl-, —O—C₁₋₁₀ alkenyl-, —C₁₋₁₀ cycloalkenyl-, —O—C₁₋₁₀ cycloalkenyl-, —C₁₋₁₀ alkynyl-, —O—C₁₋₁₀ alkynyl-, —C₃₋₃₀ aryl-, —O—C₃₋₃₀ aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl. In some embodiments, the molecule comprising “Core 2” comprises one or more pending Michael acceptor moieties. In some embodiments, a Michael acceptor comprises an acrylate or methacrylate moiety.

In some embodiments, an elastomer can be prepared according to Scheme 2. In some embodiments, R comprises one or more linking groups selected from —C₁₋₁₀ alkyl-, —O—C₁₋₁₀ alkyl-, —C₃₋₃₀ alkenyl-, —O—C₁₋₁₀ alkenyl-, —C₃₋₃₀ cycloalkenyl-, —O—C₁₋₁₀ cycloalkenyl-, —C₁₋₁₀ alkynyl-, —O—C₁₋₁₀ alkynyl-, —C₃₋₃₀ aryl-, —O—C₃₋₃₀ aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl.

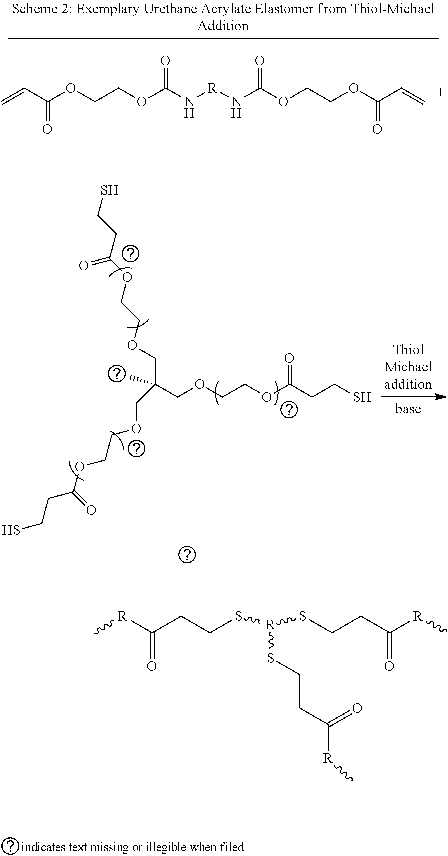

A silicone-free elastomer can be fabricated based on an elastomeric system described herein, such as for example in Scheme 1 or Scheme 2. In some embodiments, the elastomer has an elongation at break above 200%, above 300%, above 400%, above 500%, above 600%, above 700%, above 800%, above 900%, above 1000%, above 1100%, above 1200%, above 1300%, above 1400%, or above 1500%.

A silicone-free elastomer was fabricated based on urethane acrylate cured by multifunctional thiol through Michael Addition. It is as stretchable as most of the silicone elastomers, with the elongation at break above 1200% and tensile strength above 0.48 MPa. But it is much more hydrophilic than silicone materials, thus making it possible to be coated with PEDOT:PSS aqueous solution. The electrical conductivity of this elastomer can also be tuned by loading electrically conductive fillers. And a surface resistivity of 0.145 Ohm/has been achieved with loading of metal fillers up to 37 vol %, while still maintain the elongation at break up to 146%. A final conductive elastomer coated PEDOT:PSS layer has been fabricated with the target application for EMG electrode.

In some embodiments, an urethane acrylate elastomer contains urethane segments, which without wishing to be bound by any particular theory, can provide stretchability similar as the urethane but is isocyanate free. It is cured by reacting with multifunctional thiols through Michael Addition. The arm length of the multifunctional thiols can also be tuned by ethoxylation to further tune the stretchability and hydrophilicity. Without wishing to be bound by any particular theory, it is believed that the double network of hydrogen bonding between urethane linkage and the covalent bonding of the thiol-carbon crosslinking improves the toughness and stretchability of the elastomers and makes it capable of loading high amount of conductive fillers while still maintaining good stretchability. Also without wishing to be bound by any particular theory, it is believed that the hydrophilicity of the urethane acrylate/thiol network allows it to be coated with the PEDOT:PSS layer, which is otherwise very difficult to be coated on silicone based elastomers.

While metal electrodes have been directly used for many applications, they are rigid, thus not comfortable to be worn all day long. Silicone based conductive elastomers have been used in electrode application, but the silicone oil bleeding problem and poor compatibility with other materials, like PEDOT:PSS, further reduce the skin contact impedance.

This disclosure describes a urethane acrylate formulation cured by multifunctional thiols into an elastomer which is ultra-stretchable, hydrophilic, and can be loaded with large amount of fillers to provide good electrical conductivity. Due to the hydrophilicity, it can be further coated with different layers of materials for additional functionality. For example, it can be coated with PEDOT:PSS to achieve low skin-contact electrical impedance for EMG electrode applications.

In some non-limiting embodiments, a formulation can include: urethane acrylate oligomer, multifunctional thiol, base catalyst, one or more other additives, one or more fillers, and a coating.

In some embodiments, the urethane acrylate oligomer can comprise or can consist of at least one urethane linkage in the backbone and at least two acrylate functional group in the chain end; or it can comprise or consist of the product of the following general formula:

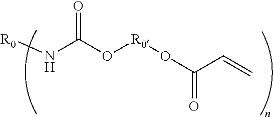

wherein R₀ can be any (hetero)hydrocarbyl groups, including aliphatic and aromatic groups; R′₀ can be any (hetero)hydrocarbyl groups, including aliphatic and aromatic groups; n can be 2, 3, 4, 5, 6, >6.

In some embodiments, the urethane acrylate oligomer can comprise or can consist of the product of the following general formula:

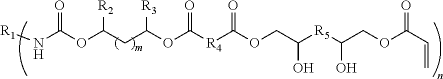

In some embodiments, R₁ comprises or consists of a hydrocarbyl group, which is carrying n —NH— groups; R₂ or R₃ each independently comprises or consists of substituents which are identical or different and interchangeable in their position, and can be chosen in some embodiments from H, alkyl or hydroxyalkyl, where alkyl can be C₁ to C₃ alkyl; m can be 0, 1, or any integer >1; R₄ comprises or consists of, an alkylene radical, cycloalkylene radical or arylene radical, which can be substituted, in particular by CH₃, Et, CH₃—(CH₂)ₙ (where n>1), H, OH, OMe, OEt, OiPr, F, Cl, Br, I, Ph, NO₂, SO₃, SO₂Me, iPr, t-Bu, sec-Bu, Et, acetyl, SH, SMe, carboxyl, aldehyde, amide, nitrile, ester, SO₂NH₃, NH₂, NMe₂, NMeH, C₂H₂, at any position where on the molecule could be substituted to one of the above functional groups can be considered or a combination there of; R₅ comprises or consists of, alkylene radical, cycloalkylene radical or arylene radical, which can be substituted, in particular by CH₃, Et, CH₃—(CH₂)n (where n>1), H, OH, OMe, OEt, OiPr, F, Cl, Br, I, Ph, NO₂, SO₃, SO₂Me, iPr, t-Bu, sec-Bu, Et, acetyl, SH, SMe, carboxyl, aldehyde, amide, nitrile, ester, SO₂NH₃, NH₂, NMe₂, NMeH, C₂H₂, at any position where on the molecule could be substituted to one of the above functional groups can be considered or a combination there of; n can be 2 to 6, or >6.

In some embodiments, the multifunctional thiol can be represented by the formula R₈—(SH)ₙ, where n is 2 to 6, or >6, R₈ includes any (hetero)hydrocarbyl groups, including aliphatic and aromatic monothiols and polythiols; R₄ may optionally further include one or more functional groups including hydroxyl, acid, ester, cyano, urea, urethane and ether groups.

In some embodiments, the multifunctional thiol can also be represented by the formula:

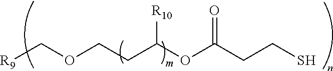

wherein R₉ comprises or consists of, hydrocarbyl of valence n in polyol compound, carrying n hydroxyl groups; R₁₀ comprises or consists of, H or methyl group; n can be 2 to 4; m can be 0, 1, or any integer>1.

The base catalyst can further comprise a tertiary amine; the tertiary amine can comprise a 5- or 6-membered aliphatic nitrogen heterocycle, which can be selected from 1,5-diazabicyclo[4.3.0]non-5-ene (DBN), 1, 8-diazabicyclo[5.4.0]undec-7ene (DBU) and 1,4-diazabicyclo[2/2/2]octane (DABCO) in an amount of 0.005-0.3 wt %, based on the total weight of the composition, or 1-(2-hydroxyethyl)pyrrolidine, 1-(2-hydroxyethyl)pyrrolidone, 1-(2-hydroxyethyl)piperidine, 1-ethylpiperazine, 1-(2-hydroxyethyl)piperazine, 1,4-bis-(2-hydroxyethyl)piperazine, 1-methylimidazole and 4-(2-hydroxyethyl)morpholine, in an amount of 0.3-7 wt % based on the total weight of the composition.

The curable composition may include one or more inorganic fillers (e.g., electrically conductive fillers). Generally, the selection and loading levels of the inorganic fillers may be used to control the electrical conductivity of the curable composition. The electrically conductive fillers include carbon based materials such as graphite, and metals such as aluminum, copper, silver, gold, nickel coated gold, etc.

Other additives can comprise dispersant, plasticizer, polymer thinner, etc. The dispersant may act to stabilize the inorganic filler particles in the composition without dispersant, the particles may aggregate, thus adversely affecting the benefit of the particles in the composition. Suitable dispersants may depend on the specific identity and surface chemistry of filler. Suitable dispersants may include at least a binding group and a compatibilizing segment. The binding group may be ionically bonded to the particle surface. Examples of binding groups for alumina particles include phosphoric acid, phosphonic acid, sulfonic acid, carboxylic acid, and the amine. The compatibilizing segment may be selected to be miscible with the curable matrix.

The elastomer can be further coated with one or more additional layers, including, without limitation, conjugated polymer PEDOT:PSS, silver nanowires, Nafion, etc.

The following clauses describe certain embodiments.

Clause 1. An elastomeric material comprising a cross-linked polymeric matrix and a filler.

Clause 2. The elastomeric material of clause 1, wherein the cross-linked polymeric matrix comprises an adduct of an unsaturated precursor and a nucleophilic precursor.

Clause 3. The elastomeric material of clause 2, wherein the unsaturated precursor comprises an acrylate.

Clause 4. The elastomeric material of clause 2, wherein the unsaturated precursor comprises a urethane acrylate.

Clause 5. The elastomeric material of clause 2, wherein the unsaturated precursor comprises an elastomeric urethane acrylate.

Clause 6. The elastomeric material of clause 2, wherein the nucleophilic precursor comprises a thiol.

Clause 7. The elastomeric material of any one of clauses 1 to 6, wherein the material is silicone-free.

Clause 8. The elastomeric material of any one of clauses 1 to 7, further comprising a coating.

Clause 9A. The elastomeric material of clause 8, wherein the coating comprises one or more of PEDOT:PSS and a sulfonated tetrafluoroethylene based fluoropolymer-copolymer.

Clause 9B. The elastomeric material of clause 8, wherein the coating further comprises a polymer binder. Clause 9C. The elastomeric material of clause 9B, wherein the polymer binder comprises a thermoplastic polymer or cross-linked polymeric matrix.

Clause 10. The elastomeric material of any one of clauses 1 to 9, wherein the filler is an inorganic filler selected from a carbon based material and a metal.

Clause 11. The elastomeric material of any one of clauses 1 to 9, wherein the filler is selected from graphite, aluminum, copper, silver, gold, and nickel coated gold.

Clause 12. An elastomeric material comprising a cross-linked polymeric matrix, wherein the cross-linked polymeric matrix comprises an adduct of an unsaturated precursor and a nucleophilic precursor, the adduct having Formula I:

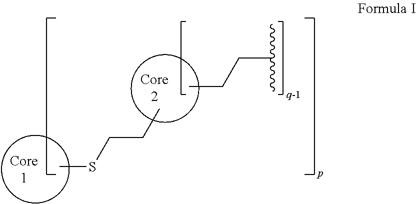

wherein in Formula I: p is any integer from 1 to 12; Core 1 comprises one or more of a substituted alkyl moiety, and one or more linking groups selected from —C₁₋₁₀ alkyl-, —O—C₁₋₁₀ alkyl-, —C₁₋₁₀ alkenyl-, —O—C₁₋₁₀ alkenyl-, —C₁₋₁₀ cycloalkenyl-, —O—C₁₋₁₀ cycloalkenyl-, —C₁₋₁₀ alkynyl-, —O—C₁₋₁₀ alkynyl-, —C₁₋₁₀ aryl-, —O—C₁₋₁₀ aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl; q is any integer from 1 to 12; and Core 2 comprises one or more linking groups selected from —C₁₋₁₀ alkyl-, —O—C₁₋₁₀ alkyl-, —C₁₋₁₀ alkenyl-, —O—C₁₋₁₀ alkenyl-, —C₁₋₁₀ cycloalkenyl-, —O—C₁₋₁₀ cycloalkenyl-, —C₁₋₁₀ alkynyl-, —O—C₁₋₁₀ alkynyl-, —C₁₋₁₀ aryl-, —O—C₁₋₁₀ aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl.

Clause 13: The elastomeric material of clause 12, wherein p is an integer from 2 to 12, an integer from 3 to 12, an integer from 3 to 5, or an integer from 3 to 6.

Clause 14. The elastomeric material of clause 12, wherein p is at least 2, at least 3, at least 4, at least 5, or at least 6.

Clause 15. The elastomeric material of clause 12, wherein p is 1, p is 2, p is 3, p is 4, p is 5, p is 6, p is 7, p is 8, p is 9, or p is 10.

Clause 16. The elastomeric material of any one of clauses 12 to 15, wherein q is an integer from 3 to 12, an integer from 3 to 5, or an integer from 3 to 6.

Clause 16. The elastomeric material of any one of clauses 12 to 15, wherein q is at least 2, at least 3, at least 4, at least 5, or at least 6.

Claude 17. The elastomeric material of any one of clauses 12 to 15, wherein q is 1, q is 2, q is 3, q is 4, q is 5, q is 6, q is 7, q is 8, q is 9, or q is 10.

Clause 18. The elastomeric material of any one of clauses 12 to 17, the adduct having Formula II:

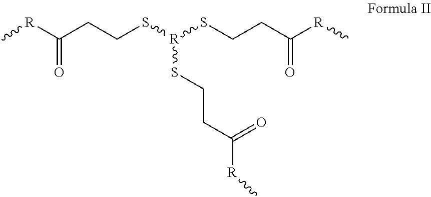

wherein in Formula II: R comprises one or more linking groups selected from —C₁₋₁₀ alkyl-, —O—C₁₋₁₀ alkyl-, —C₁₋₁₀ alkenyl-, —O—C₁₋₁₀ alkenyl-, —C₁₋₁₀ cycloalkenyl-, —O—C₁₋₁₀ cycloalkenyl-, —C₁₋₁₀ alkynyl-, —O—C₁₋₁₀ alkynyl-, —C₁₋₁₀ aryl-, —O—C₁₋₁₀ aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl.

Clause 19. The elastomeric material of any one of clauses 12 to 18, wherein the adduct is obtained by a Michael addition reaction between an urethane acrylate oligomer and a thiol comprising compound.

Clause 20. The elastomeric material of clause 19, wherein the urethane acrylate oligomer comprises a compound of formula:

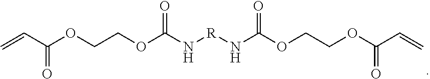

Clause 21. The elastomeric material of claim 19, wherein the urethane acrylate oligomer comprises a compound of formula: wherein R₀ can be

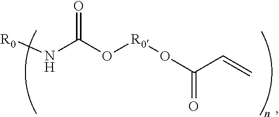

any (hetero)hydrocarbyl groups, including aliphatic and aromatic groups; R′₀ can be any (hetero)hydrocarbyl groups, including aliphatic and aromatic groups; n can be 2, 3, 4, 5, 6, >6.

Clause 22. The elastomeric material of clause 19, wherein the urethane acrylate oligomer comprises a compound of formula:

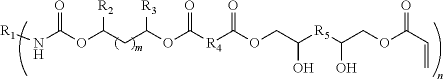

wherein R₁ comprises or consists of a hydrocarbyl group, which is carrying n —NH— groups; R₂ or R₃ each independently comprises or consists of substituents which are identical or different and interchangeable in their position, and can be chosen in some embodiments from H, alkyl or hydroxyalkyl, where alkyl can be C₁ to C₃ alkyl; m can be 0, 1, or any integer>1; R₄ comprises or consists of, an alkylene radical, cycloalkylene radical or arylene radical, which can be substituted, in particular by CH₃, Et, CH₃—(CH₂)ₙ (where n>1), H, OH, OMe, OEt, OiPr, F, Cl, Br, I, Ph, NO₂, SO₃, SO₂Me, iPr, t-Bu, sec-Bu, Et, acetyl, SH, SMe, carboxyl, aldehyde, amide, nitrile, ester, SO₂NH₃, NH₂, NMe₂, NMeH, C₂H₂, at any position where on the molecule could be substituted to one of the above functional groups can be considered or a combination there of; R₅ comprises or consists of, alkylene radical, cycloalkylene radical or arylene radical, which can be substituted, in particular by CH₃, Et, CH₃—(CH₂)ₙ (where n>1), H, OH, OMe, OEt, OiPr, F, Cl, Br, I, Ph, NO₂, SO₃, SO₂Me, iPr, t-Bu, sec-Bu, Et, acetyl, SH, SMe, carboxyl, aldehyde, amide, nitrile, ester, SO₂NH₃, NH₂, NMe₂, NMeH, C₂H₂, at any position where on the molecule could be substituted to one of the above functional groups can be considered or a combination there of; n can be 2 to 6, or >6.

Clause 23. The elastomeric material of clause 19, wherein the thiol comprising compound comprises a multifunctional thiol represented by the formula R₈—(SH)ₙ, where n is 2 to 6, or >6, R₈ includes any (hetero)hydrocarbyl groups, including aliphatic and aromatic monothiols and polythiols; R₄ may optionally further include one or more functional groups including hydroxyl, acid, ester, cyano, urea, urethane and ether groups.

Clause 24. The elastomeric material of clause 19, wherein the thiol comprising compound comprises a multifunctional thiol represented by the formula:

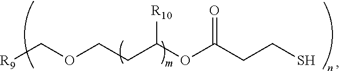

wherein R₉ comprises or consists of, hydrocarbyl of valence n in polyol compound, carrying n hydroxyl groups; R₁₀ comprises or consists of, H or methyl group; n can be 2 to 4; m can be 0, 1, or any integer>1.

Clause 25. The elastomeric material of clause 19, wherein the Michael addition reaction comprises the use of a base catalyst comprising a tertiary amine comprising a 5- or 6-membered aliphatic nitrogen heterocycle, which can be selected from 1,5-diazabicyclo[4.3.0]non-5-ene (DBN), 1, 8-diazabicyclo[5.4.0]undec-7ene (DBU) and 1,4-diazabicyclo[2/2/2]octane (DABCO) in an amount of 0.005-0.3 wt %, based on the total weight of the composition, or 1-(2-hydroxyethyl)pyrrolidine, 1-(2-hydroxyethyl)pyrrolidone, 1-(2-hydroxyethyl)piperidine, 1-ethylpiperazine, 1-(2-hydroxyethyl)piperazine, 1,4-bis-(2-hydroxyethyl)piperazine, 1-methylimidazole and 4-(2-hydroxyethyl)morpholine.

Clause 26. The elastomeric material of any one of clauses 12 to 25, further comprising a filler.

Clause 27. The elastomeric material of claim 26, wherein the filler comprises an inorganic filler selected from a carbon based material and a metal.

Clause 28. The elastomeric material of clause 26, wherein the filler comprises an inorganic filler selected from graphite, aluminum, copper, silver, gold, and nickel coated gold.

Clause 29. The elastomeric material of any one of clauses 12 to 28, further comprising a coating.

Clause 30A. The elastomeric material of clause 29, wherein the coating comprises one or more of PEDOT:PSS and a sulfonated tetrafluoroethylene based fluoropolymer-copolymer. Clause 30B. The elastomeric material of clause 29, further comprising a coating, wherein the coating comprises one or more of PEDOT:PSS, a sulfonated tetrafluoroethylene based fluoropolymer-copolymer, and/or a polymer binder. Clause 30C. The elastomeric material of clause 30B, wherein the coating comprises a polymer binder, wherein the polymer binder comprises a thermoplastic polymer or cross-linked polymeric matrix.

Clause 31. The elastomeric material of any one of clauses 1 to 30, having an elongation at break above 200%, above 300%, above 400%, above 500%, above 600%, above 700%, above 800%, above 900%, above 1000%, above 1100%, above 1200%, above 1300%, above 1400%, or above 1500%.

Clause 32. An electrode comprising the elastomeric material of any one of clauses 1 to 31.

### EXAMPLES

The urethane acrylate/multifunctional thiol elastomers with high elongation at break and hydrophilicity were formulated using the materials listed in Table 1. It is comprised with one or more urethane acrylates, one or more multifunctional thiols, a catalyst, an optional dispersant, and optional electrically conductive fillers. The elastomers can be further surface coated with hydrophilic layers. Detailed formulation for Example 1-8 in Table 2. Comparative Examples 1 and 2 in Table 2 are formed by platinum cured silicones with optional fillers.

A speed mixer (SPEEDMIXER DAC 150.1 FVZ-K, FlackTek, Inc., Landrum, S.C., ETS) was used to thoroughly mix the resins with or without adding the conductive fillers. The mixing was set at 1550 rpm/min for 35 sec, 2000 rpm/min at 20 s, and then 2000 rpm/min for 35 s without vacuum and then repeat the same procedure with vacuum @100 torr. The volume percentage of filler in each composition was calculated using the weight percentages of filler and density of the components.

The cylinder-shaped samples were made by pressing the mixed paste into a cylinder-shaped silicone rubber mold, which was then laminated with release liners on both sides. The cylinder shape gives a diameter of about 6.5 mm or 4 mm and a thickness of about 5 mm. Samples were then cured at room temperature for 3 days, followed by 2 hours at 90° C.

The coating of different materials on top of the elastomer cylinders can be done through different coating methods, including dip-casting, drop-casting, spin-coating, stencil printing, inkjet printing, roll-to-roll coating, etc. Example 2 and 5 were drop-cast by PEDOT:PSS solution and evaporated at room temperature for 1 day.

TABLE 1
Materials

| | | | Supplier |
|---|---|---|---|
| | Commercial Name | | information |
| Urethane | CN9047 | Low viscosity aliphatic urethane | Sartomer |
| Acrylate 1 | | acrylate oligomer | |
| Thiol 1 | THIOCURE ® ETTMP | Ethoxylated trimethylolpropane | Bruno Bock |
| | 1300 | tri (3-mercaptopropionate) | chemische |
| | | | Fabrik |
| Catalyst 1 | Dabco ® 33-LV | 1,4-Diazabicyclo[2.2.2]octane | Sigma Aldrich |
| | | solution | |
| Dispersant | Solplus D510 | 100% active polymeric | Lubrizol |
| 1 | | dispersant | |
| Filler 1 | E-fill 2758 | 1Au 50 Ni 40C, 100 micron | Oerlikon |
| | | Flake | |
| Coating | PH1000 | PEDOT:PSS aqueous solution | Sigma Aldrich |
| solution 1 | | | |
| Coating | Silver NW ink | Silver Nanowires 1 wt % Ag in | Nanostructured |
| solution 2 | | isopropanol (D = 55-75 nm, L = | & Amorphous |
| | | 20-40 micron) | Materials |
| Coating | Nation ™ perfluorinated | Nafion ™ perfluorinated resin | Sigma Aldrich |
| solution 3 | resin solution, | solution, 20 wt. % in lower | |
| | | aliphatic alcohols and water, | |
| | | contains 34% water | |

TABLE 2
Composition of Example and Comparative Example of Multifunctional Thiol Cured Urethane Acrylate with or without surface coating

| | Example 1 | Example 2 | Example 3 | Example 4 | Example 5 | Example 6 | Comparative | Comparative |
|---|---|---|---|---|---|---|---|---|
| | YL-082020-1 | YL-082020-2 | YL-082020-3 | YL-090202-1 | YL-080620-3 | YL-080620-7 | Example 1 | Example 2 |
| Resin A | Urethane | Urethane | Urethane | Urethane | Urethane | Urethane | Ecoflex 0030 | Ecoflex 0030 |
| | Acrylate 1 | Acrylate 1 | Acrylate 1 | Acrylate 1 | Acrylate 1 | Acrylate 1 | A | A |
| Resin A wt % | 80.6% | 32.3% | 24.8% | 24.4% | 84.7% | 83.3% | 50% | 15% |
| Resin B | Thiol 1 | Thiol 1 | Thiol 1 | Thiol 1 | Thiol 1 | Thiol 1 | Ecoflex 0030 | Ecoflex 0030 |
| | | | | | | | B | B |
| Resin B wt % | 12.9% | 5.2% | 4.0% | 3.9% | 13.6% | 13.3% | 50% | 15% |
| Catalyst | Catalyst 1 | Catalyst 1 | Catalyst 1 | Catalyst 1 | Catalyst 1 | Catalyst 1 | Catalyst 1 | Catalyst 1 |
| Catalyst wt % | 6.5% | 2.6% | 2.0% | 2.0% | 1.7% | 3.3% | 0% | 0% |
| Dispersant | Dispersant 1 | Dispersant 1 | Dispersant 1 | Dispersant 1 | Dispersant 1 | Dispersant 1 | Dispersant 1 | Dispersant 1 |
| Dispersant 1 | 0.0% | 0.0% | 0.0% | 1.4% | 0.0% | 0.0% | 0% | 0% |
| wt % | | | | | | | | |
| Filler | E-Fill 2760 | E-Fill 2760 | E-Fill 2760 | E-Fill 2760 | E-Fill 2760 | E-Fill 2760 | E-Fill 2760 | E-Fill 2760 |
| Filler wt % | 0.0% | 60.0% | 69.3% | 68.4% | 0% | 0% | 0% | 70% |
| Filler Vol % | 0 | 27 | 37 | 37 | 0 | 0 | 0 | 37 |

Test Procedures

Rheology of Curing Kinetics

The curing kinetics was measured using a parallel-plate geometry at 1% strain on an ARES Rheometer (TA Instruments, Wood Dale, Ill., US) equipped with a forced convection oven accessory at oscillating mold at frequency of 1 Hz at 90° C. through a time sweep.

Tensile Properties

For tensile tests, “dog bone” shaped samples were made by pressing the mixed paste into a dog bone-shaped silicone rubber mold, which was then laminated with release liner on both sides. The dog bone shape gives a gauge length of about 13 mm in the center straight area a width of about 6 mm in the narrowest area, and a thickness of about 1.5 mm. Samples were then cured at room temperature for 3 days, followed by 2 hours at 90° C. Then mount the “dog bones” in the Instron Universal Testing System (model 5943) series held by pneumatic clamps at a pressure, ΔP=1 psi. During the test, the samples were pulled at a rate of 75 mm/min.

Electrical Conductivity

For electrical conductivity measurements, disk-shaped samples with diameter larger than 6 mm were made by pressing the mixed paste into a disk-shaped silicone rubber mold which was then laminated with release liner on both sides. The sample was then cured at room temperature for 3 days, followed by 2 hours at 90° C. to give complete curing. Surface conductivity was then measured by Ossila Four-Point Probe System.

Results

Curing Kinetics Study

Table 3 shows the curing kinetic study by time sweep on an ARES Rheometer with oscillating mold at frequency of 1 Hz at 90° C. The gelation time is defined as G′ is equal to G″. The study shows that the gelation time can be reduced from 600 min with 1.7 wt % of DABCO-33LV to 109 min with 6.5 wt % of DABCO-33LV. The cured sample shows two ultralow glass transition in Table 4, −61.1° C. and −47.6° C., indicating microphase separated structure in the network.

TABLE 3
Rheology study for the curing kinetics and gelation time

| | | | Catalyst | Curing | Gelation time |
|---|---|---|---|---|---|
| | ID | Catalyst | (wt %) | condition | (min) |
| Example | YL- | DABCO- | 1.7 | 90° C. | 600 |
| 5 | 080620-3 | 33LV | | | |
| Example | YL- | DABCO- | 3.3 | 90° C. | 270 |
| 6 | 080620-7 | 33LV | | | |
| Example | YL- | DABCO- | 6.5 | 90° C. | 109 |
| 1 | 081720-1 | 33LV | | | |

TABLE 4
Glass Transitions of cured urethane acrylate/thiol elastomer

| | | Glass | Glass |
|---|---|---|---|
| | | Transition 1 | Transition 2 |
| | ID | (° C.) | (° C.) |
| Example 1 | YL-081720-1 | −61.1 | −47.6 |

Mechanical Performance after Different Curing Conditions

Table 5 shows the mechanical performance of Example 1 without filler loading and Example 3 with 69.3 wt % of filler loading at two different curing conditions. Both examples show that curing at r.t. for 3 days 60% of the performance of additional 2 hours at 90° C. for complete curing. 69.3 wt % of filling increases slightly the tensile strength, but dramatically reduces the elongation at break from >1200% to <250%.

TABLE 5
Mechanical Performance with Different Curing Condition

| | | | | | Tensile | Elongation | Young's |
|---|---|---|---|---|---|---|---|
| | | | Filler | | Strength | at break | Modulus |
| | | Filler | Vol % | Curing Condition | (mean (s) MPa) | (mean (s) %) | (mean (s) MPa) |
| Example 1 | YL-082020-1 | no | 0 | r.t. for 3 days | >0.48 | >1253 | 0.09 |
| | | | | | (0.05) | (116) | |
| Example 1 | YL-082020-1- | no | 0 | r.t. for 3 days + | >0.52 | >1400 | 0.136 |
| | further curing | | | 90° C. for 2 hrs | (0.04) | | (0.001) |
| Example 3 | YL-082020-3 | E-fill 2760 | 37 | r.t. for 3 days | 0.56 | 146 | 3.3 |
| | | (69.3 wt %) | | | (0.06) | (14) | (0.8) |
| Example 3 | YL-082020-3- | E-fill 2760 | 37 | r.t. for 3 days + | 0.71 | 224 | 3.6 |
| | further curing | (69.3 wt %) | | 90° C. for 2 hrs | | | |

Table 6 shows the comparison of mechanical performance of Examples and Comparative Examples. Example 1 and Comparative Example 1 compare urethane acrylate cured by multifunctional thiol with platinum-catalyzed silicones without filler loading. The urethane acrylate elastomer cured by multifunctional thiol (Example 1) shows higher elongation at break than platinum-catalyzed silicones (Comparative Example 1) with similar tensile strength. After loading with 69.3 wt % of metal fillers (E-fill 2758), thiol-cured urethane acrylate shows 224% of elongation at break (Example 3), while platinum-catalyzed silicones show only 72% of elongation at break (Comparative Example 2). Both also shows similar tensile strength.

From Table 7, for Comparative Example 1 and 2, the surface energy is too low to be coated with aqueous solution. But Example 1, 3 are quite easy to be coated with aqueous solutions, including PEDOT:PSS (Example 7 and 8), AgNW (Example 9), and Nafion (Example 10). Further surface resistivity, volume resistivity, conductivity and electrode-skin contact impedance were measured and calculated by four-point-probe in Table 8 and 9. Example 8 and 9 with PEDOT:PSS and AgNW coating on Example 3 shows the conductivity of 3.7 E+3 S/m and 6.0 E+3 S/m respectively, while Example 10 with Nafion coating shows the conductivity of 9.4 E-4 S/m. Example 3 shows the skin-electrode contact impedance of 1.25 MOhm, which is 5.5 times of gold electrode, while Example 8 and 9 with PEDOT:PSS and AgNW coating on Example 3 shows the skin-electrode contact impedance of 0.78 MOhm (3.3 times of gold electrode) and 0.76 MOhm (3.1 times of gold electrode), while Example 10 with Nafion coating shows the skin-electrode contact impedance of 1.05 MOhm (4.7 times of gold electrode).

TABLE 6
Mechanical and Electrical Performance of Examples and Comparative Examples

| | | | | | | | Tensile | | Young's | |
|---|---|---|---|---|---|---|---|---|---|---|
| | | | | | | | Strength | Elongation | Modulus | Surface |
| | | | | | Filler | | (mean (s) | at break | (mean (s) | Conductivity |
| | | Resin A | Resin B | Filler | Vol % | Curing Condition | MPa) | (mean (s) %) | MPa) | (Ohm/ [symbol] ) |
| Example 1 | YL-082020-1 | Urethane | ETTMP | no | 0 | r.t. for 3 days + | >0.52 | >1400 | 0.136 | N.A. |
| | | Acrylate | | | | 90 ° C. for 2 hrs | (0.04) | | (0.001) | |
| Comparative | Control 1 | Ecoflex | Ecoflex | no | 0 | 100° C. for 3 hrs | 0.67 | 705 | 0.03 | N.A. |
| Example 1 | | 0030 A | 0030 B | | | | (0.07) | (83) | | |
| Example 3 | YL-082020-3 | Urethane | ETTMP | E-fill 2760 | 37 | r.t. for 3 days + | 0.71 | 224 | 3.6 | 8.6E−2 |
| | | Acrylate | | (69.3 wt %) | | 90° C. for 2 hrs | | | | |
| Comparative | Control 2 | Ecoflex | Ecoflex | E-fill 2760 | 37 | 100° C. for 3 hrs | 0.71 | 71.91 | 0.98 | 1.03E−1 |
| Example 2 | | 0030 A | 0030 B | (69.3 wt %) | | | (0.13) | (0.07) | (0.18) | |

TABLE 7
Surface energy and contact angle of Examples and Comparative Examples.

| | | | | | | | Surface | Water |
|---|---|---|---|---|---|---|---|---|
| | | | | | Filler | | energy | contact |
| | | Resin A | Resin B | Filler | Vol % | Curing Condition | (mN/m) | angel (°) |
| Example 1 | YL-082020-1 | Urethane | ETTMP | no | 0 | r.t. for 3 days + | 35.9 | 71.0 |
| | | Acrylate | | | | 90° C. for 2 hrs | | |
| Comparative | Control 1 | Ecoflex | Ecoflex | no | 0 | 100° C. for 3 hrs | 16.9 | 109.9 |
| Example 1 | | 0030 A | 0030 B | | | | | |
| Example 3 | YL-082020-3 | Urethane | ETTMP | E-fill 2760 | 37 | r.t. for 3 days + | 36.3 | 72.2 |
| | | Acrylate | | (69.3 wt %) | | 90° C. for 2 hrs | | |

TABLE 8
Electrical Conductivity

| | | | Surface | Volume | |
|---|---|---|---|---|---|
| | | Surface | Resistivity | Resistivity | Conductivity |
| | | coating | (Ohm/□) | (Ohm-m) | (S/m) |
| Example 1 | YL-082020-1 | No coating | Not | Not | Not |
| | | | measurable | measurable | measurable |
| Example 3 | YL-082020-2 | No coating | Not | Not | Not |
| | | | Measurable | measurable | measurable |
| Example 7 | YL-082020-1 | Example 1 | 8.7E+3 | 1.4E+1 | 1.2E−1 |
| | | with | (8.0E+3) | (1.3E+1) | (0.8E−1) |
| | | PEDOT:PSS | | | |
| | | coating | | | |
| Example 3 | YL-082020-3 | No coating | 8.6E−2 | 1.40E−4 | 7E+3 |
| | | | (1.0E−2) | (0.17E−4) | (0.9E+3) |
| Example 8 | YL-082020-3 | Example 3 | 1.84E−1 | 2.9E−4 | 3.7E+3 |
| | | with | (0.7E−1) | (1.1E−4) | (1.2E+3) |
| | | PEDOT:PSS | | | |
| | | coating | | | |
| Example 9 | YL-082020-3 | Example 3 | 0.11 | 1.7E−4 | 6.0E+3 |
| | | with AgNW | (0.03) | (0.4E−4) | (1.5E+3) |
| | | coating | | | |
| Example 10 | YL-082020-3 | Example 3 | 1.05E+6 | 1.7E+3 | 9.4E−4 |
| | | Nafion | (0.6E+6) | (1.0E+3) | (8.2E−4) |
| | | coating | | | |

TABLE 9
Electrode-Skin Contact impedance

| | Skin contact impedance at | Relative to |
|---|---|---|
| | 30 min (MOhm) | gold electrode |
| Example 3 | 1.25 | 5.5:1 |
| Example 8 | 0.78 | 3.3:1 |
| Example 9 | 0.76 | 3.4:1 |
| Example 10 | 1.05 | 4.7:1 |

Embodiments of the invention may be used to fabricate components of a sensor, an electrode, or the like, or may be implemented in conjunction with a sensor, an electrode, or any wearable electrode, sensor, or device known in the art or yet to be developed. Biopotential electrodes are described for example by Chi et al., “Dry-Contact and Noncontact Biopotential Electrodes: Methodological Review,” IEEE Reviews in Biomedical Engineering, Vol. 3, 2010. Electrodes are also described by Kisannagar et al., “Fabrication of Silver Nanowire/Polydimethylsiloxane Dry Electrodes by a Vacuum Filtration Method for Electrophysiological Signal Monitoring,” ACS Omega 2020, 5, 18, 10260-10265.

A number of patent and non-patent publications are cited herein in order to describe the state of the art to which this disclosure pertains. The entire disclosure of each of these publications is incorporated by reference herein.

While certain embodiments are described and/or exemplified herein, various other embodiments will be apparent to those skilled in the art from the disclosure. The present disclosure is, therefore, not limited to the particular embodiments described and/or exemplified, but is capable of considerable variation and modification without departure from the scope and spirit of the appended claims.

1. An elastomeric material comprising a cross-linked polymeric matrix, wherein the cross-linked polymeric matrix comprises an adduct of an unsaturated precursor and a nucleophilic precursor, the adduct having Formula I: 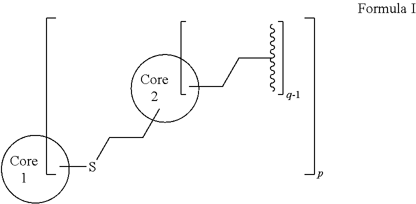
wherein in Formula I:
p is any integer from 1 to 12;
Core 1 comprises one or more of a substituted alkyl moiety, and one or more linking groups selected from —C₁₋₁₀ alkyl-, —O—C₁₋₁₀ alkyl-, —C₁₋₁₀ alkenyl-, —O—C₁₋₁₀ alkenyl-, cycloalkenyl-, cycloalkenyl-, alkynyl-, alkynyl-, —C₁₋₁₀ aryl-, —O—C₁₋₁₀ aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl;
q is any integer from 1 to 12; and
Core 2 comprises one or more linking groups selected from —C₁₋₁₀ alkyl-, alkyl-, —C₁₋₁₀ alkenyl-, —O—C₁₋₁₀ alkenyl-, —C₁₋₁₀ cycloalkenyl-, —O—C₁₋₁₀ cycloalkenyl-, —C₁₋₁₀ alkynyl-, alkynyl-, —C₁₋₁₀ aryl-, aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl.

2. The elastomeric material of claim 1, wherein p is an integer from 2 to 12, an integer from 3 to 12, an integer from 3 to 5, or an integer from 3 to 6.

3. The elastomeric material of claim 1, wherein p is at least 2, at least 3, at least 4, at least 5, or at least 6.

4. The elastomeric material of claim 1, wherein p is 1, p is 2, p is 3, p is 4, p is 5, p is 6, p is 7, p is 8, p is 9, or p is 10.

5. The elastomeric material of claim 1, wherein q is an integer from 3 to 12, an integer from 3 to 5, or an integer from 3 to 6.

6. The elastomeric material of claim 1, wherein q is at least 2, at least 3, at least 4, at least 5, or at least 6.

7. The elastomeric material of claim 1, wherein q is 1, q is 2, q is 3, q is 4, q is 5, q is 6, q is 7, q is 8, q is 9, or q is 10.

8. The elastomeric material of claim 1, the adduct having Formula II: 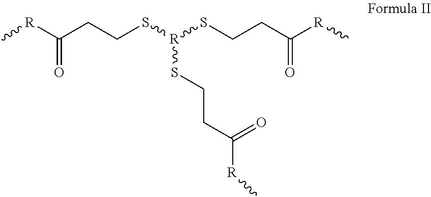
wherein in Formula II:
R comprises one or more linking groups selected from —C₁₋₁₀ alkyl-, —O—C₁₋₁₀ alkyl-, —C₁₋₁₀ alkenyl-, —O—C₁₋₁₀ alkenyl-, —C₁₋₁₀ cycloalkenyl-, cycloalkenyl-, alkynyl-, alkynyl-, —C₁₋₁₀ aryl-, aryl-, —O—, —S—, —C(O)—, —C(O)O—, —OC(O)—, —C(O)S—, —SC(O)—, —OC(O)O—, —N(R^{b})—, —C(O)N(R^{b})—, —N(R^{b})C(O)—, —OC(O)N(R^{b})—, —N(R^{b})C(O)O—, —SC(O)N(R^{b})—, —N(R^{b})C(O)S—, —N(R^{b})C(O)N(R^{b})—, —N(R^{b})C(NR^{b})N(R^{b})—, —N(R^{b})S(O)_{w}—, —S(O)_{w}N(R^{b})—, —S(O)_{w}O—, —OS(O)_{w}—, —OS(O)_{w}O—, —O(O)P(OR^{b})O—, (O)P(O—)₃, —O(S)P(OR^{b})O—, and (S)P(O—)₃, wherein w is 1 or 2, and R^{b} is independently hydrogen, optionally substituted alkyl, or optionally substituted aryl.

9. The elastomeric material of claim 8, wherein the adduct is obtained by a Michael addition reaction between an urethane acrylate oligomer and a thiol comprising compound.

10. The elastomeric material of claim 9, wherein the urethane acrylate oligomer comprises a compound of formula:

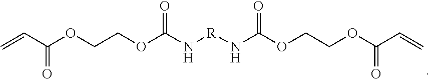

11. The elastomeric material of claim 9, wherein the urethane acrylate oligomer comprises a compound of formula: 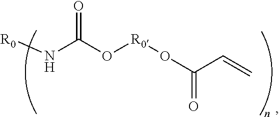
wherein R₀ can be any (hetero)hydrocarbyl groups, including aliphatic and aromatic groups; R′₀ can be any (hetero)hydrocarbyl groups, including aliphatic and aromatic groups; n can be 2, 3, 4, 5, 6, >6.

12. The elastomeric material of claim 9, wherein the urethane acrylate oligomer comprises a compound of formula: 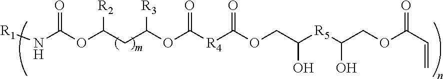
wherein R₁ comprises or consists of a hydrocarbyl group, which is carrying n —NH— groups; R₂ or R₃ each independently comprises or consists of substituents which are identical or different and interchangeable in their position, and can be chosen in some embodiments from H, alkyl or hydroxyalkyl, where alkyl can be C₁ to C₃ alkyl; m can be 0, 1, or any integer>1; R₄ comprises or consists of, an alkylene radical, cycloalkylene radical or arylene radical, which can be substituted, in particular by CH₃, Et, CH₃—(CH₂)ₙ (where n>1), H, OH, OMe, OEt, OiPr, F, Cl, Br, I, Ph, NO₂, SO₃, SO₂Me, iPr, t-Bu, sec-Bu, Et, acetyl, SH, SMe, carboxyl, aldehyde, amide, nitrile, ester, SO₂NH₃, NH₂, NMe₂, NMeH, C₂H₂, at any position where on the molecule could be substituted to one of the above functional groups can be considered or a combination there of; R₅ comprises or consists of, alkylene radical, cycloalkylene radical or arylene radical, which can be substituted, in particular by CH₃, Et, CH₃—(CH₂)n (where n>1), H, OH, OMe, OEt, OiPr, F, Cl, Br, I, Ph, NO₂, SO₃, SO₂Me, iPr, t-Bu, sec-Bu, Et, acetyl, SH, SMe, carboxyl, aldehyde, amide, nitrile, ester, SO₂NH₃, NH₂, NMe₂, NMeH, C₂H₂, at any position where on the molecule could be substituted to one of the above functional groups can be considered or a combination there of; n can be 2 to 6, or >6.

13. The elastomeric material of claim 9, wherein the thiol comprising compound comprises a multifunctional thiol represented by the formula R₈—(SH)ₙ, where n is 2 to 6, or >6, R₈ includes any (hetero)hydrocarbyl groups, including aliphatic and aromatic monothiols and polythiols; R₄ may optionally further include one or more functional groups including hydroxyl, acid, ester, cyano, urea, urethane and ether groups.

14. The elastomeric material of claim 9, wherein the thiol comprising compound comprises a multifunctional thiol represented by the formula: 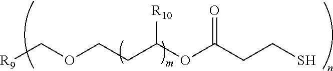
wherein R₉ comprises or consists of, hydrocarbyl of valence n in polyol compound, carrying n hydroxyl groups; R₁₀ comprises or consists of, H or methyl group; n can be 2 to 4; m can be 0, 1, or any integer>1.

15. The elastomeric material of claim 9, wherein the Michael addition reaction comprises the use of a base catalyst comprising a tertiary amine comprising a 5- or 6-membered aliphatic nitrogen heterocycle, which can be selected from 1,5-diazabicyclo[4.3.0]non-5-ene (DBN), 1, 8-diazabicyclo[5.4.0]undec-7ene (DBU) and 1,4-diazabicyclo[2/2/2]octane (DABCO) in an amount of 0.005-0.3 wt %, based on the total weight of the composition, or 1-(2-hydroxyethyl)pyrrolidine, 1-(2-hydroxyethyl)pyrrolidone, 1-(2-hydroxyethyl)piperidine, 1-ethylpiperazine, 1-(2-hydroxyethyl)piperazine, 1,4-bis-(2-hydroxyethyl)piperazine, 1-methylimidazole and 4-(2-hydroxyethyl)morpholine.

16. The elastomeric material of claim 1, further comprising an inorganic filler selected from a carbon based material and a metal.

17. The elastomeric material of claim 1, further comprising an inorganic filler selected from graphite, aluminum, copper, silver, gold, and nickel coated gold.

18. The elastomeric material of claim 1, further comprising a coating, wherein the coating comprises one or more of PEDOT:PSS, a sulfonated tetrafluoroethylene based fluoropolymer-copolymer, and/or a polymer binder.

19. The elastomeric material of claim 18, wherein the coating comprises a polymer binder, wherein the polymer binder comprises a thermoplastic polymer or cross-linked polymeric matrix.

20. An electrode comprising the elastomeric material of claim 1.
